(19) United States
(12) Patent Application Publication
(10) Pub. No.: US 2019/0294820 A1
(43) Pub. Date: Sep. 26, 2019

(54) CONVERTING PLAINTEXT VALUES TO PSEUDONYMS USING A HASH FUNCTION

(71) Applicant: EntIT Software LLC, Sunnyvale, CA (US)

(72) Inventors: Luther Martin, Sunnyvale, CA (US); Timothy Roake, Sunnyvale, CA (US)

(21) Appl. No.: 15/926,392

(22) Filed: Mar. 20, 2018

(51) Int. Cl. G06F 21/62; H04L 9/06

(52) U.S. Cl. CPC G06F 21/6254; H04L 9/0618; H04L 9/0643

(57) ABSTRACT

A technique includes accessing data, which represents a plurality of plaintext values and converting the plaintext values to pseudonym values, which are associated with a predetermined statistical distribution. Converting the plaintext values includes, for a given plaintext value, repeatedly applying a hash function to provide corresponding hash values based on the given plaintext value; and combining the hash values to provide a pseudonym value, which corresponds to the given plaintext value.

### BACKGROUND

A business organization (a retail business, a professional corporation, a financial institution, and so forth) may collect, process and/or store data that represents sensitive or confidential information about individuals or business organizations. For example, the data may be personal data that may represent names, residence addresses, medical information, salaries, banking information, and so forth. The data may be initially collected or acquired in “plaintext form,” and as such may be referred to as “plaintext data.” Plaintext data refers to ordinarily readable data. As examples, plaintext data may be a sequence of character codes, which represent the residence address of an individual in a particular language; or the plaintext data may be a number that that conveys, for example, a blood pressure reading.

### BRIEF DESCRIPTION OF THE DRAWINGS

FIG. 1 is a schematic diagram of a computer system according to an example implementation.

FIG. 2 is a flow diagram depicting a technique to convert a plaintext value to a pseudonym value using hashes according to an example implementation.

FIG. 3 is a statistical distribution of pseudonym values where each pseudonym value is generated using a single hash function iteration according to an example implementation.

FIG. 4 is a statistical distribution of pseudonym values where each pseudonym value is generated using two hash function iterations according to an example implementation.

FIG. 5 is a statistical distribution of pseudonym values where each pseudonym value is generated using three hash function iterations according to an example implementation.

FIG. 6 is a flow diagram depicting a technique to use a hash function to provide a pseudonym value according to an example implementation.

FIG. 7 is an illustration of a machine readable storage medium storing machine executable instructions to apply a one way conversion function to determine a pseudonym value according to an example implementation.

FIG. 8 is a schematic diagram of an apparatus to convert a dataset representing plaintext data to a dataset representing pseudonyms based on hashes derived from the plaintext data according to an example implementation.

### DETAILED DESCRIPTION

For purposes of controlling access to sensitive information (e.g., information relating to confidential or sensitive information about one or more business enterprises and/or individuals) plaintext data items, which represent the sensitive information, may be converted, through a process called “pseudonymization,” into corresponding pseudonymns, or pseudonym values. In this context, a “plaintext data item” (also referred to as “plaintext,” or a “plaintext value” herein) refers to a unit of data (a string, an integer, a real number, and so forth) that represents ordinarily readable content. As examples, a plaintext data item may be a string of character codes that corresponds to data that represents a number that conveys, in a particular number representation (an Arabic representation, for example), a blood pressure measurement, a salary, and so forth. The pseudonym value ideally conveys no information about the entity associated with the corresponding plaintext value. The pseudonymization process may or may not be reversible, in that reversible pseudonymization processes allow plaintext values to be recovered from pseudonym values, whereas irreversible pseudonymization processes do not.

The pseudonymization process may serve various purposes, such as regulating access to sensitive information and allowing the sensitive information to be analyzed by third parties. For example, the sensitive data may be personal data, which represents personal information about the public, private and/or professional lives of individuals. In some cases, it may be useful to process pseudonymized data to gather statistical information about the underlying personal information. For example, it may be beneficial to statistically analyze pseudonymized health records (i.e., health records in which sensitive plaintext values have been replaced with corresponding pseudonym values), for purposes of gathering statistical information about certain characteristics (weights, blood pressures, diseases or conditions, diagnoses, and so forth) of particular sectors, or demographics, of the population. The pseudonymization process may, however, potentially alter, if not destroy, statistical properties of the personal information. In other words, a collection of plaintext values may have certain statistical properties that are represented by various statistical measures (means, variances, ranges, distributions, expected and so forth). These statistical properties may not be reflected in the corresponding set of pseudonym values, and accordingly, useful statistical information about the personal information may not be determined from the pseudonymized data.

As a more specific example, one way to convert plaintext data (e.g., personal data, such as data representing health records, salaries, addresses, and so forth) into a corresponding set of pseudonyms is to encrypt the plaintext data. However, encrypting data may destroy statistical properties of the data. For example, the encryption of plaintext data that has a Gaussian, or normal statistical distribution, may produce a set of pseudonym values, which have an associated uniform probability distribution.

In accordance with example implementations that are described herein, a pseudonymization process converts plaintext values into corresponding pseudonym values in a process that preserves a statistical distribution of the plaintext values. Moreover, in accordance with example implementations, the pseudonymization process is irreversible. In other words, in accordance with example implementations, it may be quite challenging, if not impossible, to reconstruct the plaintext values from the pseudonym values.

More specifically, in accordance with example implementations, a pseudonymization engine converts plaintext values (assumed to have a normal statistical distribution) to pseudonym values that have a normal statistical distribution. In accordance with example implementations, the pseudonymization engine repeatedly applies a hash function (a cryptographic hash function, such as an SHA-2 hash function or an SHA-3 hash function, as examples) in the conversion of each plaintext value.

The output of a hash function is a pseudorandom value. In accordance with the Central Limit Theorem, the sum of several such hash values may approximate or reach a normal, or Gaussian distribution. More specifically, if “H” represents a hash function and “H(x)” represents the application of the hash function to an input value x, the sum H(x)+H(H(x))+H(H(H(x))) approximates, if not exactly matches, a normal distribution. In accordance with example implementations that are described herein, a pseudonym value is determined by repeatedly applying a hash function and adding the resulting hashes together, as set forth above in the summation above. In accordance with example implementations, the resulting set, or collection, of pseudonym values has a predetermined statistical distribution (a Gaussian or normal distribution, as an example); and due to the hash function being a one way function, the pseudonymization may be irreversible.

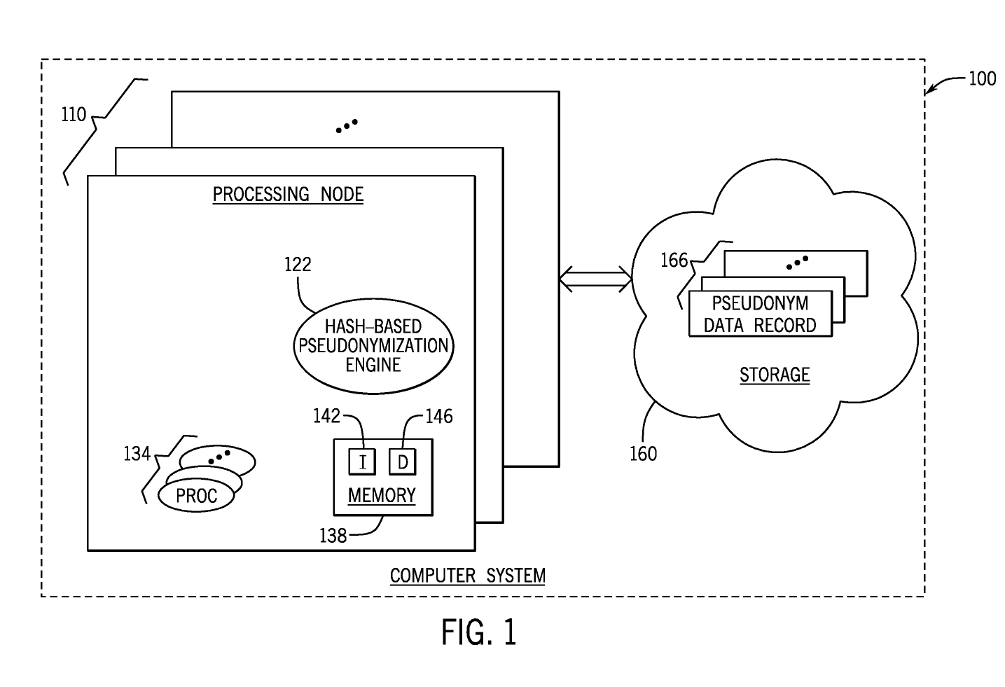

Referring to FIG. 1, as a more specific example, in accordance with some implementations, a computer system 100 may include one or multiple hash-based pseudonymization engines 122 (herein called “pseudonymization engines 122”). In general, the computer system 100 may be a desktop computer, a server, a client, a tablet computer, a portable computer, a public cloud-based computer system, a private cloud-based computer system, a hybrid cloud-based computer system (i.e., a computer system that has public and private cloud components), a private computer system having multiple computer components disposed on site, a private computer system having multiple computer components geographically distributed over multiple locations, and so forth.

Regardless of its particular form, in accordance with some implementations, the computer system 100 may include one or multiple processing nodes; and each processing node 110 may include one or multiple personal computers, workstations, servers, rack-mounted computers, special purpose computers, and so forth. Depending on the particular implementations, the processing nodes 110 may be located at the same geographical location or may be located at multiple geographical locations. Moreover, in accordance with some implementations, multiple processing nodes 110 may be rack-mounted computers, such that sets of the processing nodes 110 may be installed in the same rack. In accordance with further example implementations, the processing nodes 110 may be associated with one or multiple virtual machines that are hosted by one or multiple physical machines.

In accordance with some implementations, the processing nodes 110 may be coupled to a storage 160 of the computer system 100 through network fabric (not depicted in FIG. 1). In general, the network fabric may include components and use protocols that are associated with any type of communication network, such as (as examples) Fibre Channel networks, iSCSI networks, ATA over Ethernet (AoE) networks, HyperSCSI networks, local area networks (LANs), wide area networks (WANs), global networks (e.g., the Internet), or any combination thereof.

The storage 160 may include one or multiple physical storage devices that store data using one or multiple storage technologies, such as semiconductor device-based storage, phase change memory-based storage, magnetic material-based storage, memristor-based storage, and so forth. Depending on the particular implementation, the storage devices of the storage 160 may be located at the same geographical location or may be located at multiple geographical locations. Regardless of its particular form, the storage 160 may store pseudonymized data records 164 (i.e., data representing pseudonyms, or pseudonym values, generated as described herein).

In accordance with some implementations, a given processing node 110 may contain a pseudonymization engine 122, which is constructed to, for a given plaintext value, repeatedly apply a hash function (a cryptographic hash function, as an example) to produce multiple hash values, which are added together to produce the corresponding pseudonym value, as described herein. Due to the use of a hash function and the corresponding hash values, the pseudonymization process is irreversible, in accordance with example implementations.

In accordance with example implementations, the processing node 110 may include one or multiple physical hardware processors 134, such as one or multiple central processing units (CPUs), one or multiple CPU cores, and so forth. Moreover, the processing node 110 may include a local memory 138. In general, the local memory 138 is a non-transitory memory that may be formed from, as examples, semiconductor storage devices, phase change storage devices, magnetic storage devices, memristor-based devices, a combination of storage devices associated with multiple storage technologies, and so forth.

Regardless of its particular form, the memory 138 may store various data 146 (data representing plaintext values, pseudonym values, hash function outputs, mathematical combinations of hash values, intermediate results pertaining to the pseudonymization process, and so forth). The memory 138 may store instructions 142 that, when executed by one or multiple processors 134, cause the processor(s) 134 to form one or multiple components of the processing node 110, such as, for example, the pseudonymization engine 122.

In accordance with some implementations, the pseudonymization engine 122 may be implemented at least in part by a hardware circuit that does not include a processor executing machine executable instructions. In this regard, in accordance with some implementations, the pseudonymization engine 122 may be formed from whole or in part by a hardware processor that does not execute machine executable instructions, such as, for example, an application specific integrated circuit (ASIC), a field programmable gate array (FPGA), and so forth. Thus, many implementations are contemplated, which are within the scope of the appended claims.

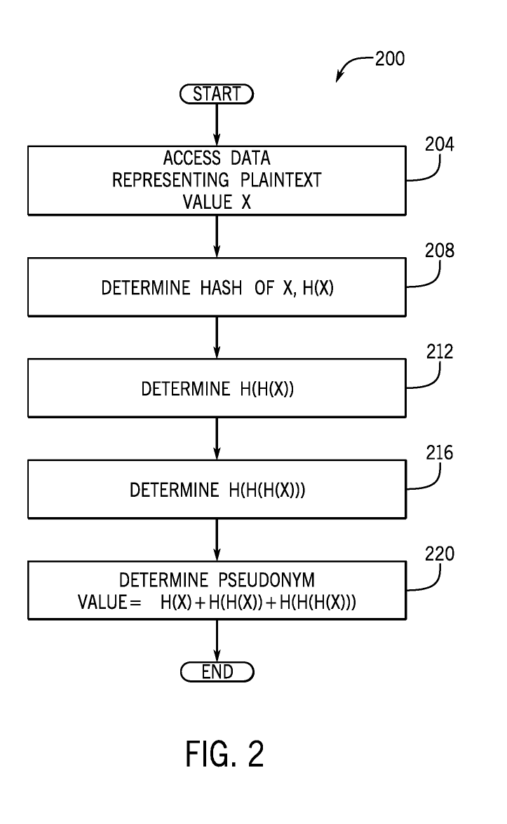

FIG. 2 depicts a flow diagram 200 of a process that may be used by the pseudonymization engine 122 for purposes of converting a plaintext value to a pseudonym value, in accordance with example implementations. Referring to FIG. 2 in conjunction with FIG. 1, pursuant to the technique 200, the pseudonymization engine 122 accesses (block 204) data representing a plaintext value. For example, the data may be derived from one of the plaintext data records 164 of FIG. 1. Next, the pseudonymization engine 122 determines (block 208) a hash value. In particular, in accordance with example implementations, if the plaintext value is represented by “x,” then block 208 involves the pseudonymization engine 122 applying a hash function (an SHA-2 or SHA-3 hash function, for example), represented by “H,” to the plaintext value x to determine a particular hash value (represented by “H(x)”). Next, pursuant to block 212, in accordance with some implementations, the pseudonymization engine 122 applies the hash function H again. As depicted in block 212, the pseudonymization engine 122 applies the hash function H to the hash value determined in block 208 for purposes of determining another hash value, H(H(x)).

As depicted in FIG. 2, the above-described process may be repeated, i.e., the pseudonymization engine 122 may apply multiple hash function iterations, where the engine 122, in each iteration, determines a hash based on a result of the previous iteration. In this regard, FIG. 2 depicts, in block 216, the pseudonymization engine 122 determining another hash value by applying the hash function H to the hash result from block 212 to determine a hash value, H(H(H(x))). In accordance with example implementations, the pseudonymization engine 122 may therefore determine three hash values based on the hash function H and the plaintext value x; and then, pursuant to block 220, the pseudonymization engine 122 may determine the pseudonym value, which corresponds to the plaintext value x and is equal to the summation of these three hash values, i.e., pseudonymization engine 122 may set the pseudonym value equal to H(x)+H(H(x))+H (H(H(x))).

In accordance with further example implementations, the pseudonymization engine 122 may determine fewer or more than three hash values and base the determination of each pseudonym value on the summation of these hash values. For example, in accordance with further example implementations, the pseudonymization engine 122 may set the pseudonym value equal to H(x)+H(H(x)).

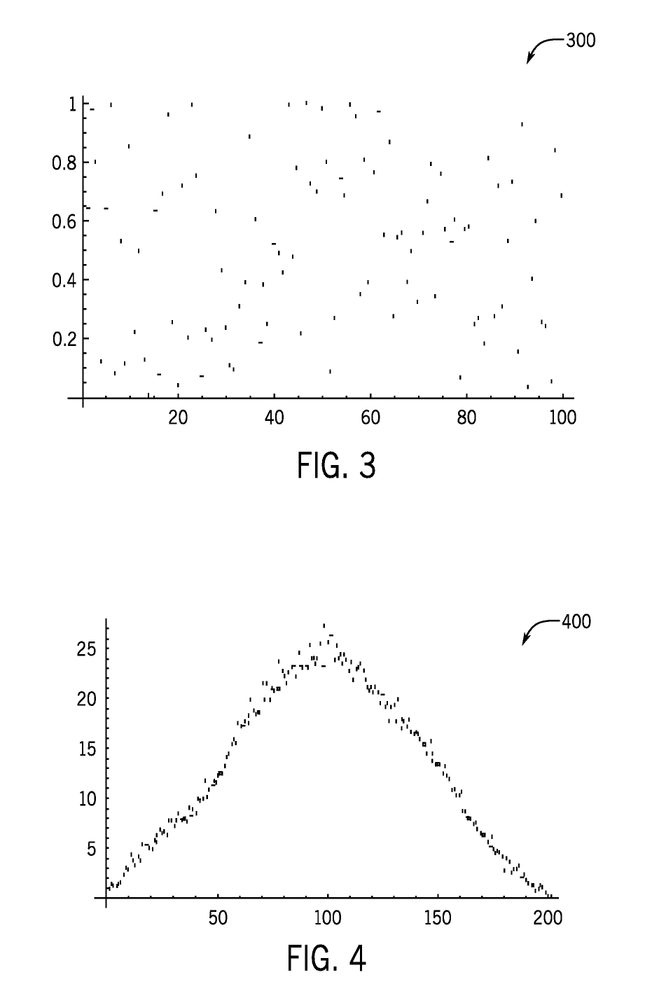

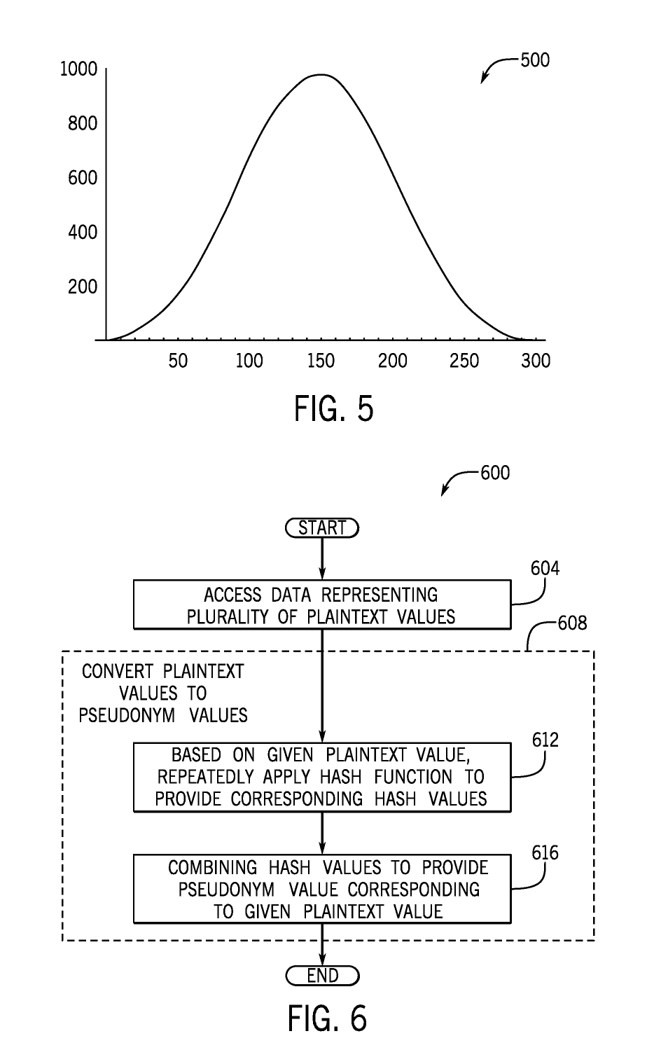

The number of hash function iterations control the statistical distribution of the pseudonym values. FIG. 3 is a probability function, or statistical distribution 300, for a set of pseudonym values generated using a single hash function iteration for each pseudonym value. In other words, the pseudonym value for a given plaintext value x is H(x). FIG. 4 is a statistical distribution 400 produced using two hash function iterations. In other words, for FIG. 4, each plaintext value x is converted to the corresponding pseudonym value by performing two hashes and adding the hashes together, i.e., the pseudonym value is set equal to H(x)+H(H(x)). FIG. 5 is a statistical distribution 500 of pseudonym values produced using three hash function iterations, i.e., a set of pseudonym values produced using the technique 200 of FIG. 2. As can be seen from FIGS. 3, 4 and 5, in accordance with example implementations, with an increasing number of hash function iterations, the corresponding statistical distribution of pseudonym values approaches, if not reaches, a Gaussian, or normal, distribution.

Moreover, in accordance with further example implementations, the pseudonymization engine 122 may further process a set of pseudonym values that are derived using a summation of hashes (such as one of the summations described above) to further manipulate statistical properties of the pseudonym values. For example, after the pseudonymization engine 122 uses one or multiple hash function iterations to reach or approximate a given distribution, such as a normal distribution, as depicted in FIG. 5, the engine 122 may then, in accordance with example implementations, scale the data to impart a certain mean and/or variance to the distribution.

The pseudonymization engine 122 may, in accordance with example implementations, apply a statistical distribution transformation function to the set of intermediate pseudonym values to further manipulate statistical properties of the resulting pseudonym dataset. For example, in accordance with some implementations, the pseudonymization engine 122 may apply a Box Muller or a polar Marsaglia transformation, as just a few examples. In this manner, the pseudonymization engine 122 may, for example, convert a set of intermediate pseudonym values having a normal statistical distribution into a set of pseudonym values that have a log-normal statistical distribution.

Referring to FIG. 6, thus, in accordance with example implementations, a technique 600 includes accessing (block 604) data representing a plurality of plaintext values and converting (block 608) the plaintext values to pseudonym values, which are associated with a predetermined statistical distribution. Converting the plaintext values may include, in accordance with some implementations, for a given plaintext value, repeatedly applying (block 612) a hash function based on the given plaintext value to provide corresponding hash values. Moreover, converting the plaintext values to pseudonyms may include combining (block 616) the hash values to provide a pseudonym value, which corresponds to the given plaintext value.

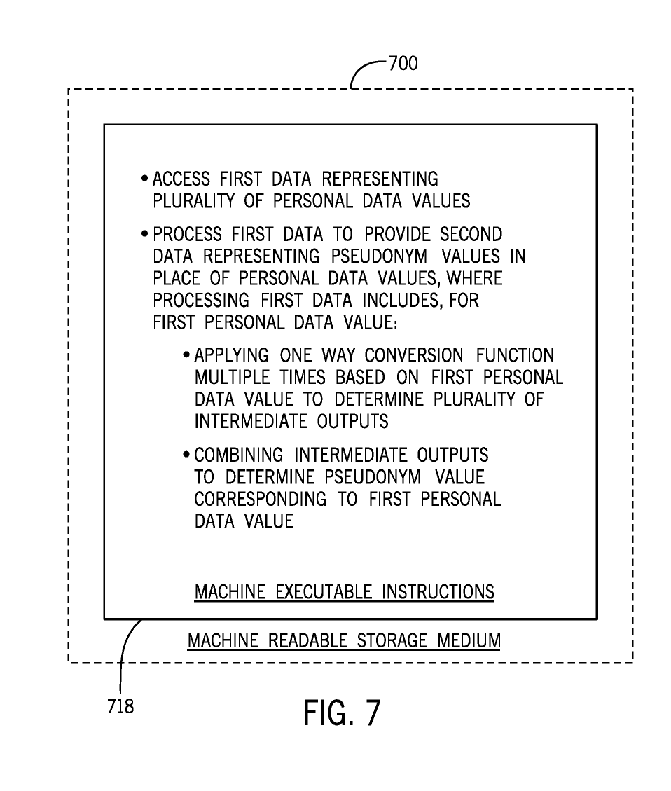

Referring to FIG. 7, in accordance with example implementations, a non-transitory machine readable storage medium 700 may store instructions 718 that, when executed by a machine, cause the machine to access first data representing a plurality of personal data values and process the first data to provide second data, which represents pseudonym values in place of the personal data values. In accordance with example implementations, the processing may include, for a first personal data value, applying a one way conversion function multiple times based on the first personal data value to determine a plurality of intermediate outputs; and combining the intermediate outputs to determine the pseudonym value that corresponds to the first personal data value.

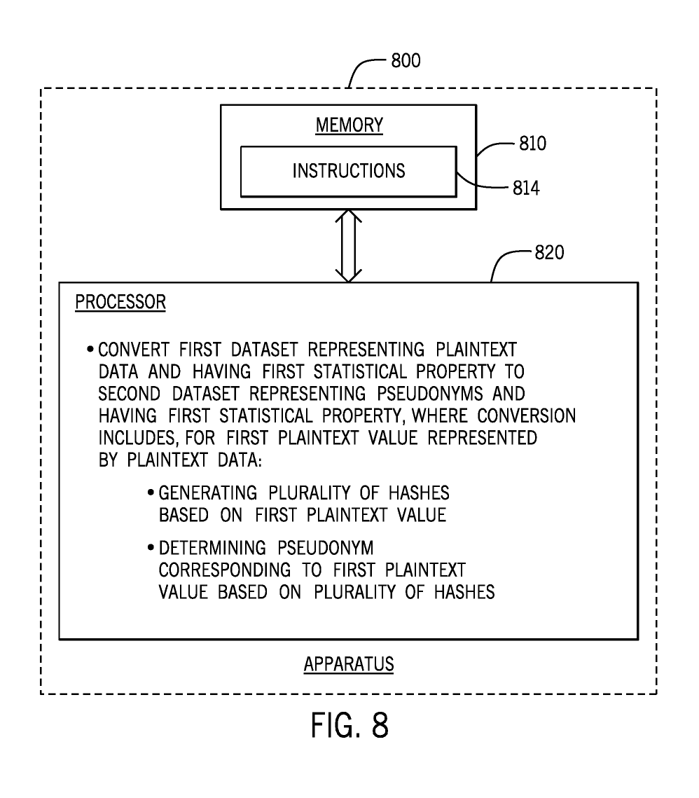

Referring to FIG. 8, in accordance with example implementations, an apparatus 800 includes at least one processor 820 and a memory 810 to store instructions 814 that, when executed by the processor(s) 820, cause the processor(s) 820 to convert a first dataset representing plaintext data and having a first statistical property to a second dataset, which represents pseudonyms that has the first statistical property. The conversion includes, for a first plaintext value that is represented by the plaintext data, generating a plurality of hashes based on the first plaintext value; and determining a pseudonym, which corresponds to the first plaintext value based on the plurality of hashes.

While the present disclosure has been described with respect to a limited number of embodiments, those skilled in the art, having the benefit of this disclosure, will appreciate numerous modifications and variations therefrom. It is intended that the appended claims cover all such modifications and variations.

What is claimed is:

1. A method comprising:
accessing data representing a plurality of plaintext values; and
converting the plaintext values to pseudonym values associated with a predetermined statistical distribution, wherein converting the plaintext values comprises, for a given plaintext value of the plurality of plaintext values:
based on the given plaintext value, repeatedly applying a hash function to provide corresponding hash values; and
combining the hash values to provide a pseudonym value corresponding to the given plaintext value.

2. The method of claim 1, wherein the predetermined statistical distribution comprises a normal distribution.

3. The method of claim 1, wherein:
repeatedly applying the hash function comprises applying the hash function three times to provide three hash values; and
combining the hash values comprises adding the three hash values tougher to provide the pseudonym value corresponding to the given plaintext value.

4. The method of claim 1, wherein repeatedly applying the hash function comprises:
applying the hash function in multiple iterations to provide the corresponding hash values, comprising in a first iteration of the multiple iterations applying the hash function to the given plaintext value to provide the corresponding hash value and for each subsequent iteration of the multiple iterations, applying the hash function to the hash value provided by the previous iteration to provide the corresponding hash value of said each subsequent iteration.

5. The method of claim 4, wherein combining the hash values comprises adding the hash values together to provide a pseudonym value for the given plaintext value.

6. The method of claim 1, where converting the plaintext values comprises performing irreversible encryption of the plaintext values.

7. The method of claim 1, further comprising:
applying a statistical distribution function to the pseudonym value to adjust a mean of the pseudonym value.

8. The method of claim 1, further comprising:
applying a statistical distribution function to the pseudonym value to adjust a variance of the pseudonym value.

9. The method of claim 1, wherein repeatedly applying the hash function comprises applying an SHA-2 hash function or an SHA-3 hash function.

10. An apparatus comprising:
at least one processor; and
a memory to store instructions that, when executed by the at least one processor, cause the at least one processor to:
convert a first dataset representing plaintext data and having a first statistical property to a second dataset representing pseudonyms and having the first statistical property, wherein the conversion comprises, for a first plaintext value represented by the plaintext data:
generating a plurality of hashes based on the first plaintext value; and
determining a pseudonym corresponding to the first plaintext value based on the plurality of hashes.

11. The apparatus of claim 10, wherein the instructions, when executed by the at least one processor, cause the at least one processor to apply a hash function multiple times to generate the plurality of hashes.

12. The apparatus of claim 11, wherein the instructions, when executed by the at least one processor, cause the at least one processor to:
apply the hash function in multiple iterations to provide the hash values, comprising in a first iteration of the multiple iterations applying the hash function to the first plaintext value to provide a first hash value and for each subsequent iteration of the multiple iterations, applying the hash function to the hash value provided by the previous iteration to provide the corresponding hash value of said each subsequent iteration.

13. The apparatus of claim 11, wherein the hash function comprises an SHA-2 hash function or an SHA-3 hash function.

14. The apparatus of claim 11, wherein the instructions, when executed by the at least one processor, cause the at least one processor to:
apply the hash function to the first plaintext value to provide a first hash;
apply the hash function to the first hash to a provide a second hash;
apply the hash function to the second hash to provide a third hash; and
determine the pseudonym corresponding to the first plaintext value based on a summation of the first hash, the second hash and the third hash.

15. The apparatus of claim 10, wherein the first dataset has the same mean of the second dataset.

16. A non-transitory machine readable storage medium storing instructions that, when executed by a machine, cause the machine to:
access first data representing a plurality of personal data values;
process the first data to provide second data representing pseudonym values in place of the personal data values, wherein processing the first data comprises, for a first personal data value of the plurality of personal data values:
applying a one way conversion function multiple times based on the first personal data value to determine a plurality of intermediate outputs; and
combining the intermediate outputs to determine the pseudonym value corresponding to the first personal data value.

17. The storage medium of claim 16, wherein the instructions, when executed by the machine, cause the machine to apply an irreversible conversion function to determine the token.

18. The storage medium of claim 16, wherein the storage medium stores instructions that, when executed by the machine, cause the machine to add the intermediate outputs together to determine the pseudonym value.

19. The storage medium of claim 16, wherein:
the instructions, when executed by the machine, cause the machine to apply the one way conversion function three times to determine three intermediate outputs;
the instructions, when executed by the machine, cause the machine to add the three intermediate outputs together to determine the pseudonym value; and
the second data has a statistical property shared in common with the first data.

20. The storage medium of claim 16, wherein the storage medium stores instructions that, when executed by the machine, cause the machine to apply a statistical distribution function to the second data to adjust a mean or a variance of the second data.
